(19) United States
(12) Patent Application Publication
(10) Pub. No.: US 2005/0256875 A1
(43) Pub. Date: Nov. 17, 2005

(54) System for managing and outputting audio data

(75) Inventor: Johannes Rietschel, Zuerich (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: BARIX AG, Zurich (CH)

(21) Appl. No.: 10/524,731

(22) PCT Filed: Aug. 22, 2003
(86) PCT No.: PCT/CH03/00567

§ 371 Date: Feb. 16, 2005

(30) Foreign Application Priority Data
Aug. 27, 2002 (CH) 1462/02

(51) Int. Cl. G06F 7/00

(52) U.S. Cl. 707/10

(57) ABSTRACT

A system including at least one content server including at least one processor, data storage, and at least one network interface; at least one terminal including at least one processor, an internal data storage, and at least one network interface; and a network by which the at least one content server and the at least one terminal can be connected via their respective network interfaces for data transmission. The content server includes a management data processing program providing specific terminals with specific files (audio, control protocols, commands) (without actively outputting the same), the at least one terminal outputs audio files, and the at least one terminal periodically and autonomously collects, or more precisely, updates files specifically provided for the terminal via a TCP/IP protocol, especially HTTP or FTP, on the content server, and outputs such via the media output according to a control protocol stored in the terminal.

### TECHNICAL FIELD

The present invention relates to a system, comprising at least one content server, at least one terminal device, as well as at least one network, by means of which the content server and the or the plurality of terminal devices are connected for data transfer by means of the respective network interfaces.

### DESCRIPTION OF THE BACKGROUND ART

Due to the fact that practically everywhere quite reliable and quick connection to company networks or the internet is available via dedicated lines as well as due to the possible compression of data thanks to highly efficient methods like MP3, WMA, AAC etc., the digital transmission of audio clips or even audio contents of several hours has become possible basically without problems. State of the art is the online streaming of internet radio stations, the downloading and saving of music files using pay services, exchange services, etc., as well as the playback of this downloaded content on the PC, by means of audio output of hi-fi systems as well as the burning of CD's.

In this broad context for example U.S. Pat. No. 6,385,596 describes secure streaming, i.e. this document is dealing with how audio data can be protected from access by third parties during transmission.

WO 02/17099 substantially describes wireless audio streaming, i.e. the streaming of audio data using wireless (telephone-) networks. The essential element of this document is to have a local server in the network, which then streams (transfers) the audio files to the wireless telephones.

U.S. 2002/0013852 is a document in which music is imported by means of the WWW, is then transferred to a server and subsequently from this server by means of a local area network LAN to the corresponding terminal devices. A portal is provided on the web, on which one can chose content for streaming, wherein these streams are transmitted to the PC by means of a broad band connection, on the PC these streams are buffered and then quickly forwarded to devices by means of Ethernet or wireless networks. An important point of this document is that the memory and processing capacity of a local PC is used for keeping the terminal device small and simple.

### SUMMARY OF THE INVENTION

The objective of the invention is therefore to provide a system, which in a cost effective and reliable, as well as easily supervisable and installable manner allows the targeted and selective output of audio files from a content server to terminal devices. It in particular relates to a system comprising at least one content server with at least one processor, means for storing data as well as with at least one network interface, it additionally comprises at least one terminal device with at least one processor, internal means for storing data and at least one network interface, further comprising a network, by means of which the at least one content server and the at least one terminal device are connected for data transfer by means of the respective network interfaces.

This object is achieved in that on the content server a management data processing program is provided, which makes specific audio files available to specific terminal devices, wherein at least one terminal device comprises a media output device for the output of audio files, and wherein the at least one terminal device periodically and self dependently fetches the audio files which are made available on the content server specifically for the terminal device using a TCP/IP protocol, or updates these files, and in accordance with a protocol saved in the terminal device outputs these files using the media output device.

A key element of the invention is therefore that a content server is provided which controls the output on the terminal devices. This however is not set up such that the content server actively controls the terminal devices in that it activates the terminal devices by means of data packets, but in the reverse manner, namely in that the terminal devices periodically and self-dependently consult the content server and fetch the information which is relevant for them. This way installation and management are substantially simplified, since for example if a terminal device is installed in a LAN and a content server on the WWW is used, the presence of a firewall does not cause any problems. The content server only makes specific audio files available for specific terminal devices by using corresponding management data processing programs which are provided on the content server, without sending the audio files actively to the terminal devices. Collisions with possibly present firewalls can thereby be avoided. The intelligent terminal devices fetch the files which are made available on the content server periodically, or only check whether the content made available on the content server has changed at all, respectively. The audio files are temporarily stored on the terminal device and are output by this terminal device according to a direction protocol by using a specifically provided media output channel of the terminal device. In contrast to classical streaming it is in case of repeating audio files possible to avoid a permanently high network load (audio files are ideally only downloaded once). In addition to that it can be avoided that in case of high network load interruptions of the output audio files can be heard. In principle the used network can be a network of any structure which has the ability of routing or it can also be of any possible segment-wise mixed technology (cable, wireless, optical), wherein the terminal device and the content server are either directly connected to this network or by means of a commercially available interface/converter. In particular the use of a dial up connection can be interesting, preferably realised with a modem which is integrated into the terminal device, if no local network is available.

For each specific terminal device it is according to the presently proposed method or the presently proposed system, respectively, possible to compose specific audio files on the content server and to configure the access of the terminal devices to the content server. The speed of the periodic inquiries of the terminal devices can be adjusted in accordance with needs and applications. For applications in the field of telephone on hold music, typically checking for new contents every 24 hours will be sufficient. For applications in which up to date news or information should be provided (weather warnings, news, etc.), or in applications in which checking of the state of the system should be carried out every minute, it might be useful to provide inquiries of the terminal device every thirty seconds.

The files which are fetched by the terminal devices can either be continually be output by means of the media output or only once as controlled by the corresponding direction protocol. If output should be provided continuously it might be preferred to have a repetitive scheme of outputting of individual files as defined in the direction protocol.

The network connection can be realised by means of a modem (dedicated line or dial up), and in particular it is possible to configure the terminal device such that for establishing a network connection it autonomously selects a point of presence (POP) via the modem.

According to a first embodiment of the present invention the transmission of the data is carried out using HTTP, FTP, SSL, TLS or SMTP protocols. The use of these standard protocols provides a particularly simple set up of the content server and for example the use of SSL can provide the security during data transmission as is necessary in the context of copyrights.

Since often data can only be exchanged between a local network and a content server by means of intermediate servers or generally intermediate devices, and since these intermediate devices often request e.g. authentication or log in, in these situations a simple communication between the content server and the terminal device located in the local network is not possible. In this case it is advisable to provide an automatic possibility to allow this authentication or log in for this intermediate device. If for example the transmission of the data is carried out using http, correspondingly protocols for the communication with proxy servers or the transmission of data via proxy serves to and from the content server, respectively, to support and to configure, respectively, are to be provided. These protocols, after corresponding configuration subsequently allow an automatic input for example of a user id and of a password, so that the terminal device is able to autonomously fetch data from the content server after log in or authentication on the server, respectively. The configuration does not necessarily have to be carried out by means of corresponding input devices on the terminal device, but it is preferably, in case of very simply designed terminal devices, possible to carry out this configuration by means of a second device (conventional network computer) which is provided in the local network for example by using a browser interface.

The terminal devices as used in such a system preferably are provided with a media output in the form of a loudspeaker, and/or of a standard (Chinch) audio output and/or with a telephone interface and/or with a headphone jack. In other words preferentially these are dedicated devices which are selectively designed for the output of audio files. Ideally the terminal devices are designed such that they configure themselves automatically upon connection autonomously by means of automatic choice of an IP address (e.g. DHCP or other methods which are initiated by the terminal device autonomously) and which establish a first contact to the content server. If for example in the terminal devices specific addresses of content servers are already stored upon manufacturing (e.g. in RAM, EEPROM or in ROM) and if upon the first contact with such a content server also the serial number of the terminal device (together with the associated IP address) is transmitted to the content server, it is possible without any further influence of the person installing the system after a simple connection to the network and if need be to a power supply (if not systems e.g. POE, Power over Ethernet are used), to directly and immediately download and subsequently output audio content, which is made available on the content server (Plug and Play in the true sense of the word). Another possibility is to store standard audio content upon manufacturing into the non volatile memory of the device, it will then allow the device to play audio content after installation even without network connection.

If for example such audio services are made available by corresponding providers, it is possible to make accessible corresponding audio files already upon recording of the order in a manner which is adapted to the client's needs on the content server for the client (e.g. a specific type of background music with periodically repeating messages), wherein already the serial no. of the terminal devices which are delivered to the client are linked with the audio files made available. Subsequently only the terminal devices with the corresponding serial nos. have to be delivered to the client and the client simply connects these terminal devices by means of a simple connection to the network cable (e.g. LAN) and the power supply, respectively, in order to subsequently automatically and without any further configuration have an output of the audio files as made available on the content server.

As an alternative or in addition it is, as additionally preferred, possible, to provide the terminal device with one or several possibilities for connecting them to local telephones and/or a local telephone system. If such a telephone connection is present in addition to that at least one interface for the connection to an external telephone line should be present. This way, the terminal device can also be installed by means of a simple connection, and the terminal device then acts as a telephone switchboard which can be controlled or configured, respectively, via the content server. On the content server for example typical and client specific texts for on hold are made available. The management of such texts for on hold can be structured very simply, since it is for example possible to keep these texts or melodies, respectively, up to date (bought by the client is for example the service to have always up to date music in the on hold, without having to care about it), and it is additionally very simply possible to provide specific texts depending on the time of the day or at holidays. Correspondingly in such a situation the terminal device is designed such that calls coming in through the external telephone line are fed into an on hold loop, in particular depending on the state of the local telephone system, of the local telephones (if for example the lines of a certain department are busy) and/or depending on a targeted input (e.g. on Saturdays no telephone calls are taken) and to play at least one audio file in accordance with a protocol, if need be interactively.

Preferably, the direction protocol in the terminal device controls the output and playback, respectively, of the audio files in relation to sequence and/or time. Preferably the terminal devices in addition to that periodically and autonomously fetch from the content server direction protocols which are specifically provided for the respective terminal device and/or the current time, or they update this information. The direction protocols may among other things also provide instructions as to how often the terminal device should check the status of the files on the content server (frequency of request). Also other files like for example upgrades of the software on the terminal devices etc. can be made available for downloading by the terminal devices on the content server.

A further possibility of using the content server is also given for the field of services, in particular if devices are hired: if the device for a certain time is not able to establish a connection with the content server, or if the content server sends a blocking signal to the terminal device (e.g. due to non payment of the services), the terminal device switches off the audio output channel or it switches to a certain file (e.g. “device blocked”) and unlocking can be carried out by the service provider using the content server any time.

For checking the state of the terminal devices it might be advantageous to make the terminal devices transfer a signature, version or check sum as a confirmation to the content server after having completed the download of audio files or direction protocols, respectively. The accesses and/or transactions and/or signatures and/or versions and/or check sums as carried out or transmitted, respectively by the terminal devices are then logged in the management data processing program on the content server, and it is possible to check the state of the total system or of individual terminal devices in particular by using a web browser.

An important advantage of the proposed system in addition consists in the possibility to distribute the requests of the terminal devices on the content server by attribution of staged request times (defined in the direction protocol as made available to each individual terminal device) optimally, in order to use the available band width ideally at all times. Preferably the requests are correspondingly distributed equally if similar terminal devices are used.

Such a system is particularly simple if one configures the individual terminal devices and/or the content server by means of a web browser, and if the devices can be checked with respect to their status by using the web browser. A client who for example has bought a certain music service can thus interactively modify the corresponding choice on the content server by means of a web browser after having logged in. He can for example choose to have certain blocks more frequently (for example advertising elements or specific announcements) or he can choose between different types of music, if this is defined so in the service contract. In particular if the terminal devices are used for feeding in music on hold it might be absolutely necessary that the client can modify the audio files according to his needs also on short notice. The proposed configuration by means of a web browser provides a particularly simple possibility, for example in case of an unexpected necessary amendment of the on hold sequence, to modify the on hold system from the client's side. Analogously it may be possible to use a standard e-mail to the content server for switching from an occupied telephone system to an unoccupied telephone system (SMTP-protocol).

Such a system is also useful for specific output of announcements for example in public buildings etc. In this case the terminal devices in addition to that are provided with at least one local interface (for example trigger knob), by means of which the output of specific audio files or combinations of audio files, in particular in the form of messages and/or music files, can be triggered. Preferably, each local interface (i.e., e.g. specific knobs on the terminal device) are attributed specific protocols in the terminal device, which coordinate the sequences of audio files in case of activation of the local interface (for example one knob for English output of the message, another knob for a German output of the messages, different types of messages like for example economy, sports, etc.).

In particular in the context of such a system for the specific output of messages it may prove advantageous to, in addition to the audio files, analogously manage graphic files, and to output these in a coordinated manner with the audio files at the terminal device. For example it is possible to output in coordination with the corresponding audio files pictures or small movie sequences by means of a small screen which is provided on the terminal device. This way it is possible to keep updated messages most efficiently (in particular in respect of the data transfer).

Further preferred embodiments of the system according to the invention are described in the dependent claims.

Furthermore, the present invention relates to the use of a system as it has been described above, as an on hold system in the telephone network, for the generation of background music in particular in hotels and/or business locations, for the management of audio information or audio advertisements, respectively, in elevators, public spaces, toilets, and/or for the targeted output of messages at specifically provided information posts.

Furthermore the present invention relates to a method for the management and the output of audio files by using a system comprising at least one content server with at least one processor, means for storage of data as well as at least one network interface, comprising at least one terminal device with at least one processor, internal means or storing data as well as at least one network interface, as well as comprising one network, by means of which the at least one content server and the at least one terminal device are in data connection by means of the corresponding network interfaces. The method is characterised in that on the content server there is provided a management data processing program, which makes available specific audio files to specific terminal devices, that the at least one terminal device outputs the audio files by means of a media output channel, and that the at least one terminal device periodically and self-dependently fetches the audio files made specifically available on the content server using a TCP/IP protocol, or updates this information, respectively, and outputs them in accordance with a direction protocol saved on the terminal device by means of the media output channel. Preferentially, this method is used by means of a system as it has been described above.

Furthermore the present invention relates to a management data processing program for use on a content server of a system, as it has been described above. In other words it relates to a data processing program, which makes specific audio files and if need be other files in downloadable manner available to specific terminal devices, and which data processing program allows the configuration and supervision of individual terminal devices in particular preferentially by means of a web browser. The software may be structured as a script solution, in particular in PHP on a standard web server. The software may also be a self standing software package with integrated web server, wherein preferentially C#, Java or similar programming languages useful for such applications may be used.

Furthermore the present invention relates to a terminal device for use in a system, as it has been described above. To this end the terminal device exclusively comprises at least one processor, internal means for storing data as well as at least one network interface as well as one media output channel, wherein the media output channel maybe a loudspeaker and/or interfaces for connection to local and/or external telephone systems. The use of such very simply structured terminal devices without any other peripherals like for example drives of data carriers, key pads, printers, etc., provides a particularly simple system. Furthermore it can be made sure that audio files, which are made available to the terminal device and correspondingly are temporarily stored on the device, can not be transferred to data carriers on the terminal device which might violate copyrights.

Since the terminal devices are anyway preferentially designed or programmed, respectively, in a way that they configure themselves upon connection automatically (automatic attribution of an IP address as well as automatic self-dependent establishment of the connection with the content server), further I/O interfaces are not necessary.

Preferentially the terminal devices can be equipped in embedded technology with incorporated flash memory. Terminal devices may have a memory extension by means of commercially available media like compact flash, memory stick, SD or MMC card etc., and it is in particular possible to structure the storage media such that it may also be charged/recorded on a commercially available PC or adapter or maybe amended thereon.

### DETAILED DESCRIPTION OF THE EMBODIMENTS

The invention describes a system with which the known techniques for transmission of audio files via the internet are used in order to quickly and reliably distribute in a wide network (typically company network or the internet) of centrally administered files to many small and PC-independent terminal devices, which are directly, via modems, wireless networks or via routers/firewall connected to the internet, as well as to supervise these devices as such and to control them.

The system comprises the following components
a) Content server: This is an application which is typically hosted on a web server, which allows to
   authorise users and to protocol actions by users
   keep files of any kind, in particular however music files on the server
   to protocol requests by connected devices (c)
   to transfer to requesting devices (c) upon request files and/or commands
   to record if communication of devices has not happened and to note the status
b) a communication system, typically the internet or a company intranet (LAN) comprising communication lines in various physical forms (wireless, optical, cable, also heterogeneous segment by segment), routers, firewalls etc., wherein on this network the communication is possible by means of standard protocols (TCP/IP, HTTP, FTP, SMTP, SSL, etc.) from the devices to the central web server without any hindrance (typically however not in the other direction, i.e. establishing the connection from the server to the devices is typically prevented by firewalls and NAT routers).
c) Intelligent terminal devices, which however as a rule are designed simply and reliably without specific user interfaces, with the possibility to have enough memory available (for example RAM, non volatile memory like for example flash memory, compact flash, memory stick, SD card, MMC card, hard disc etc.) for the desired application for the music files or other files.

It is also possible to have several content servers available (for example mirrors), for, in particular in case of many terminal devices, always providing optimal accessibility.

The terminal devices of the system actively communicate via the communication system with the content server, in defined intervals in time contact this server on the one hand for providing supervision of the terminal device (dead man principle), and on the other hand in order to learn from the content server, whether there is provided an amendment of the content for this specific device as output by the device. If this is the case, the device downloads the files from an internet file server as indicated by the server, wherein this internet file server typically, but not necessarily, is the same server as the content server, and the device downloads them into the internal memory of the device, subsequently confirms to the content server the terminated download by means of transmission of a signature or of a version no., and then treats the downloaded files. Usually these files are audio content, but it may also be scripts (directions, direction protocols), new operating system software for the device, changed configuration for the device etc. So far in the fields “music on hold” or “background music” systems are available in which either the audio content is sent by means of CD, tape, memory chip, via post, company transport or messenger, or alternatively, the systems are contacted by a central computer and correspondingly charged by the central computer analogously.

By means of the invention the management of such music systems is substantially improved and simplified, and new applications become possible. This in particular emerges from the following aspects of the invention:
a) File server and web server are nowadays practically and discretionarily scalable.
   Due to the fact that the communication is established FROM the side of the device, if the system is designed correspondingly, shortage of band width can be avoided.
b) The server can attribute different “request times” to the devices and thereby distribute the load (optimal use of the band width).
c) The communication by means of available TCP/IP networks usually does not imply connection fees and as a rule also no other fees.
d) “Forgetting” to charge/plug a conventional medium (CD, tape, etc.) is not possible.
e) The operator of the system can at any time get a picture of the status of the whole system and of each individual device, i.e. broken devices which are not noticed will not be possible any more.
f) The operator of the system can remotely control the devices, he may take them out of operation or make them operative again.
g) New “content” can be distributed in a controllable manner to each of the devices depending on the adjustment of the “request times” within very short time.
h) Time dependent control commands etc. can be distributed using the same transport mechanism as well as software updates.
i) The data as distributed are stored IN the device and can not be copied to CD's or the like (as this is so simply possible using PC's), which provides an enhanced copyright protection, which can not be assured if such files are made available on conventional PC's.
j) The devices install themselves almost automatically (automatic or autonomous, respectively, attribution of IP addresses as well as autonomous self-dependent first contact with the content server) are free from wear, and they automatically reboot after a breakdown of the grid.
k) The devices can be controlled locally by means of interfaces and can then output specific audio files, while the standard audio stream is interrupted, e.g. “evacuation” (specific control in case of emergency), “It is 19:00, we close and we wish you a nice evening” (specific control at a specific moment in time) “2^{nd} floor, men's department” (control in an elevator depending on the position of the elevator, corresponding advertising information can also be output in dependence on the floor level).
l) Depending on the network connection charging of the devices can take place much more quickly than if analogue methods are used (CD, tape, call).
m) Optionally the devices may be delivered with pre-programmed content, and are then directly operable even without network contact.
n) Due to the fact that network technology is used, the requests on the content server arrive appearing equal via the network, even if different terminal devices are connected to the network by means of different forms of communication (fixed network connection, wireless, modem) and can thus be treated uniformly.

Also completely new applications like for example “news box” or “weather box”, which all the time keep up to date messages WITHOUT that these messages have to be streamed are possible and can, if need be, be supported by providing visual data. Possible are for example message stations in train stations, on which upon pressing a button specific up to date information can be triggered.

The proposed simplified updating of audio files on a terminal device can in addition to that be used in the context of telephone systems. Correspondingly terminal devices can be provided, which, in addition to network interfaces, are provided with an interface for connecting it to an external telephone network and with a connector for a local telephone or a local telephone network. A client who acquires such a terminal device together with the service for management or updating of on hold texts and on hold music can get this terminal device, and then connect it to a network connection, a power connection as well as into the line of the external telephone system to the local telephone system. The terminal device subsequently configures itself automatically (e.g. automatic attribution of an IP-address by means of DHCP of the network server, or autonomous self-initiated definition of an IP-address by means of the terminal device in analogy to auto-IP) and automatically initiates a first contact with the content server (first communication). Either the client gets a standard service like for example on hold music in case of occupied line, then from the client's side no further steps of configuration are necessary, since on the content server the corresponding information in connection with the serial no. of the device is already made available in a specific manner. Alternatively it is possible that the client gets the object of the on hold loop in amendable manner. Correspondingly the client can configure his device on the content server by means of a web browser (for example choose a message that at this moment the office is closed and that no telephones can be taken). This configuration may also be initiated by means of other protocols like e.g. SMTP, ftp etc. This central administration simplifies the maintenance and the updating of such systems substantially and the fact that the audio files are additionally stored locally on the terminal device prevents that in case of a temporary breakdown of the network the on hold system is immediately made inoperable.

Further applications are for example possible in the context with terminal devices which are provided with interfaces on which sensors are provided. In this case for example audio content can be played depending on the actual presence of persons, so for example advertising in changing cubicles, lavatories, etc.

To sum up, the following advantages or basic ideas can be formulated:

The use of standard networks for
Reduction of costs (no dial up fees),
Increase of reliability (all devices are updated and give feedback)
On-line system supervision and control
Distribution of the current time to the devices for time management (device does never have to be adjusted)
By means of the idea that the terminal device contacts the central server, usually firewalls etc. are no obstacle
Downloadable scripts (direction protocols) (e.g. play this from 8-12, then something else from 12-1, then this until 4 and interrupt this every 30 seconds with “xxx”)
“Embedded” architecture in order to avoid the typical PC problems (high power need, unsafe storage of data, intrusion problems, mechanical wear, management)
Use of conventional, wear free and cheap storage media in the device like e.g. internal flash memory, compact flash, SD cards, etc.

1-26. (canceled)

27. A system comprising
at least one content server including at least one processor, means for storing data, and at least one network interface;
at least one terminal device including at least one processor, means for storing data, and at least one network interface;
one network, by which the at least one content server and the at least one terminal device are in data connection by their respective network interfaces,
wherein the content server further includes a management data processing program configured to make specific audio files available to specific terminal devices,
wherein the at least one terminal device further includes a media output channel for output of audio files,
wherein the at least one terminal device periodically and self-dependently gets/fetches from the content server the audio files made available specifically for the terminal device by a TCP/IP protocol, or updates them, respectively, and
wherein the terminal device outputs the audio files depending on a direction protocol that is saved in the terminal device continuously, or in repetition, or only once, by the media output channel.

28. A system according to claim 27, wherein the network and/or the network connection includes wire technology or wireless technology.

29. A system according to claim 27, wherein the network connection includes a modem.

30. A system according to claim 29, wherein the terminal device automatically dials a point of presence (POP) via the modem for establishing a network connection.

31. A system according to claim 27, wherein the transmission of the data takes place via HTTP, FTP, SSL, TLS, or SMTP protocols.

32. A system according to claim 27, wherein the transmission of the data takes place via HTTP, and further protocols for the communication with proxy servers or for the transmission of data via proxy server from and to the content server can be supported or configured, respectively.

33. A system according to claim 27, wherein the at least one terminal device is provided with, as a media output channel, a loudspeaker and/or a head phone jack, and/or one or plural connectors for connection of local telephones and/or a local telephone system, wherein in a case of such a telephone connector at least one interface for connection to an external telephone line is provided.

34. A system according to claim 33, wherein the terminal device is configured to receive incoming calls via the external telephone line and to put the received calls into an on hold loop, which is structured in function of a state of a local telephone system or of local telephones and/or depending on specific input, and which plays at least one audio file in accordance with a direction protocol if need be in an interactive manner.

35. A system according to claim 27, wherein the protocol in the terminal device controls the output or play-back of the audio files with respect to sequence and/or time.

36. A system according to claim 27, wherein the terminal devices further periodically and self-dependently fetches and/or updates direction protocols made available on the content server specifically for each individual terminal device and/or a current time.

37. A system according to claim 27, wherein the terminal devices transfer a signature, version, or check sum as a confirmation to the content server in a case of complete download of audio files or direction protocols, respectively.

38. A system according to claim 37, wherein accesses having taken place or transmitted, respectively, and/or the transactions and/or the signatures and/or the versions and/or the check sums from the terminal devices are logged on the content server in the management data processing program, and on the content server a state of a system of a whole system or of individual terminal devices can be checked by using a web browser.

39. A system according to claim 27, wherein requests of the terminal devices on the content server are substantially equally distributed by attribution of staged request times.

40. A system according to claim 27, wherein the individual terminal devices and/or the content server can be configured by a web browser and can be checked in respect of their status by the web browser.

41. A system according to claim 27, wherein the terminal devices are further configured for direct streaming of audio files from the content server.

42. A system according to claim 27, wherein the terminal devices further include at least one local interface, by which an output of specific audio files or a combination of audio files, in a form of messages and/or music files, can be triggered, wherein direction protocols specifically made available in the terminal device are attributed to the local interfaces, wherein the protocols are coordinating a sequence of audio files upon activation of the local interfaces.

43. A system according to claim 27, wherein the terminal devices are equipped in embedded technology with internal flash memory.

44. A system according to claim 27, wherein the terminal devices are provided with a memory extension by commercially available memory media of at least one of compact flash, memory stick, SD card, or MMC card.

45. A system according to claim 44, wherein the memory media are configured to be charged/recorded and modified on a commercially available PC or adapter.

46. A system according to claim 27, wherein in addition to the audio files, analogously graphic files are managed, which are output at the terminal device in coordination with the audio files.

47. A system according to claim 27, wherein the management data processing program is programmed on the content server as a script solution.

48. A system according to claim 27, wherein the management data processing program is coded as an independent software package on the content server with integrated web server in C#, Java, or in another programming language.

49. Use of a system according to claim 27 as an on hold center in a telephone network, for generation of background music, for management of audio information and audio advertisement, respectively, and/or for specific output of messages on specifically provided information posts.

50. A method for management and output of audio files by use of a system comprising:
at least one content server including at least one processor, means for storing data, and at least one network interface;
at least one terminal device including least one processor, means for storing data, and at least one network interface;
a network, by which the at least one content server and the at least one terminal device are in data connection by their respective network interfaces;
wherein, the content server further includes a management data processing program, by which specific audio files are made available to specific terminal devices;
wherein the at least one terminal device outputs the audio files by a media output channel,
wherein the at least one terminal device periodically and self-dependently fetches and updates, respectively, the audio files as specifically made available on the content server for the specific terminal device by a TCP/IP protocol, and
wherein it outputs these files in accordance with a protocol saved in the terminal device by using the media output channel.

51. A management data processing program for use on a content server of a system according to claim 27.

52. A terminal device for use in a system according to claim 27, wherein the terminal device exclusively comprises at least one processor, means for storing data, at least one network interface, and one media output channel, wherein the media output channel is a loud speaker and/or interfaces for connection to a local and/or external telephone system.
